(19) United States
(12) Patent Application Publication
(10) Pub. No.: US 2018/0260446 A1
(43) Pub. Date: Sep. 13, 2018

(54) SYSTEM AND METHOD FOR BUILDING STATISTICAL PREDICTIVE MODELS USING AUTOMATED INSIGHTS

(71) Applicant: FARMERS INSURANCE EXCHANGE, WOODLAND HILLS, CA (US)

(72) Inventor: Daniel SHOHAM, Encinitas, CA (US)

(73) Assignee: FARMERS INSURANCE EXCHANGE, WOODLAND HILLS, CA (US)

(21) Appl. No.: 15/914,656

(22) Filed: Mar. 7, 2018

Related U.S. Application Data
(60) Provisional application No. 62/468,768, filed on Mar. 8, 2017.

(51) Int. Cl. G06F 17/30; G06N 5/04; G06N 99/00

(52) U.S. Cl. CPC G06F 17/30525; G06N 99/005; G06N 5/04; G06F 17/30584

(57) ABSTRACT

A system and method are described to improve computer performance of statistical predictive models through the creation of automated insights. The method involves apportioning some of the modeling data to create an Insights Dictionary. Each entry in the Insights Dictionary is a label-value pair that is present in the apportioned data. For each entry, statistical descriptors of the Target, for example it's average, are computed among all members of the apportioned set where the label-value pair is present. Entries that are not statistically significant are aggregated with related peer entries until they are statistically significant or cannot be further aggregated. The Insights Dictionary is then used as a lookup table to transform raw predictors in the remaining modeling data set into insights, automatically generated features that are likely to be more predictive, when typical model-building tools are used, than in their raw original state.

### CROSS-REFERENCE TO RELATED APPLICATIONS

This application claims the benefit of U.S. Provisional Application No. 62/468,768 filed Mar. 8, 2017, the content of which is incorporated by reference for all that it discloses.

### FIELD

Embodiments of the present invention improve computer-implemented methodologies for building statistical predictive models, such as by automating the insight generation step.

### BACKGROUND

In prior systems, the process of building a statistical predictive model, includes (1) the gathering of tagged historical data, (2) the development of insights, and (3) the training of a statistical predictive model that endeavors to predict the tag utilizing the insights. “Insights”, in this context, are defined as elements of understanding of the drivers of the connection between the predictive data and tags that are reduced into individual algorithms executed against the raw data. Practitioners sometimes use terms such as Feature Engineering, Preprocessing, Variable Creation, and others to refer to this concept. The quantity the predictive model will, when used with future live data, endeavor to predict is called here the “Tag” or the “Target” (the two terms are used here interchangeably). Insight creation is generally considered to be at the heart of the artistry of statistical predictive model building and requires practitioners who individually, or though collaboration, are skilled in the arts of algorithm development as well as the domain of the model usage environment. Insights, together with or instead of raw data predictors, are availed to a statistical predictive method, for example Linear Regression or Neural Network, to produce a predictive model of the tag. While it is sometimes possible to build economically viable statistical predictive models directly from the raw data, without the use of any Insights, in general, models built with good Insights can dramatically outperform, on whichever metric of performance is relevant in the situation, raw data-only models.

For example, a statistical predictive model might be one that endeavors to flag potentially fraudulent insurance claims from among a population of legitimate claims. Historical data for such an example model may include a list of prior, and now closed, insurance claims and associated parameters that were known at the time the claims were processed. Tagging, in this example, may be an identification, for each listed historical claim, if it is now, with the benefit of hindsight, believed that the claim was legitimate or fraudulent. In this example, a skilled practitioner, one who has skills in the domains of fraud control and algorithm development, would identify insights that may be gleaned from the raw historical data that may be indicative of the presence of fraud. For example, a high count of recently filed claims by the same claimant may be indicative of fraudulent behavior. This insight can be actualized by an algorithm that counts the number of recently filed claims by the same claimant as of the time of each listed historical claim. In this example, the final step would be the development of a statistical predictive model, for example, a Stepwise Logistic Regression model, using a standardized modelling tool, for example the SAS System, marketed by the SAS Institute, utilizing a combination of raw data and Insights variables to predict the tag.

A weakness of the current methodology is the reliance on the artistry of practitioners who develop the Insights. Because the development of good Insights requires significant skills in domains that are not naturally related, for example Fraud Control and Algorithm Development, it is often difficult to find individuals who have mastered both. Often Insight development requires the awkward collaboration of individuals who are not accustomed to working together, for example fraud control specialists with extensive police or security background collaborating with computer scientists and mathematicians. Additionally, the process often has many manual steps and one-off coding tasks, with opportunities for errors and inefficiencies. Because the Insight generation process is largely that of artistry, there is no organized reproducible template that is assured to produce state of the art Insights.

Insight generation is a particularly difficult problem when the raw data includes natural language text, for example transcribed phone calls or claim representative log notes. Standard modelling techniques are designed for quantitative predictors, or predictors that have a small number of possible values, for example claimant gender, that can be easily transformed into quantitative predictors, for example by assigning 0 and 1 to the two possible values. While techniques that transform natural language text into quantitative predictors do exist, particularly for short text snippets, such as single phrases or sentences, these are generally not domain specific. The artistry of linguistics is yet another domain of expertise that is distinctive from algorithm development and the subject domain, such as fraud control.

Likewise, the raw data may include elements that require yet additional distinctive domains expertise to affect good Insights. For example, geographic raw data, such as a claimant zip code, may require someone skilled in the domain of geo-coding and demography to affect good Insights. Raw data gleaned from Social Media sources, such as postings on the Facebook Social Medial Website, provided by Facebook Inc., may require someone skilled in that domain. Raw data that is of a coded form, for example the employee-ID of the claim representative who interacts with the claimant, may require someone skilled with the coding structure, if any, and human resources factors, to generate good Insights.

### SUMMARY

A computationally efficient system and method are provided that automatically generate Insights from tagged raw data. In an alternative embodiment, Insights are automatically generated from quantitative, categorical, natural language, geographical, temporal, and coded raw data.

As described herein, a portion of the tagged data is set aside for the creation of Insights. That portion, called herein the Insight Set, is not used in the subsequent model training and model evaluation processes so as to avoid unfavorable overtraining situations. For each raw predictor, the Insight Set is used to generate one or more Insights by individually metering descriptors of the distribution of the Target as a function of the individual predictor

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings:

FIG. 1 is a diagram illustrating a paradigm used for predictive statistical model building and usage;

FIG. 2 is a diagram illustrating a model-building portion of an overall predictive statistical model building process;

FIG. 3 is a diagram illustrating a model-building portion of an overall predictive statistical model building process using automated insights, in accordance with an embodiment of the invention;

FIG. 4 is a diagram illustrating an overview of a process for generating and aggregating insights, in accordance with an embodiment of the invention;

FIG. 5 is a flow diagram illustrating a portion of a process for generating raw insights, in accordance with an embodiment of the invention;

FIG. 6 is a flow diagram illustrating a portion of a process for generating aggregated insights, in accordance with an embodiment of the invention;

FIG. 7 is a flow diagram illustrating a portion of a process for using generated insights in a predictive statistical modeling system, in accordance with an embodiment of the invention; and

FIG. 8 is a diagram illustrating an example of an application of insights to a predictive statistical model, in accordance with an embodiment of the invention.

### DETAILED DESCRIPTION

Embodiments of the present invention improve the predictive statistical modeling through the application of computer algorithms to transform modeling-ready raw data into modeling-ready insights-enhanced data. Although modeling-ready data takes many forms, including, for example, but not limited to, Flat Files, SQL Tables, Excel Documents, SAS Data Sets, and many others known to skilled artisans. In this description the term “Records File”, or “File”, is used to refer to any data structure that includes a collection of “Records”, each representing one exemplar, and each Record including an equal number of predefined “Fields”. Each Field represents an element of information pertaining to the exemplar and is assigned a unique “Label”. In each Record, each Field has a “Value” representing the actual information content of the exemplar. If one of the Fields is the quantity that the desired model endeavors to predict, then that Field is referred to as the “Target” or “Tag”, and the File as a whole is referred to as a “Tagged File”. Any Field that has an opportunity to be predictive with respect to the Target and which would normally be known or knowable at the time that the prediction would need to be made in an operational system, is referred to as a “Predictor”. Fields that are supplied by external sources are referred to as Raw Fields. Some Fields may be computed from Raw Fields in the same record by algorithms designed to improve upon the predictive powers of Raw Fields. Such computed Fields are referred to here as “Features”, and the algorithms to compute them as “Feature Extractors”. For the purpose of this description, Features created by other processes, for example through the artistry of the modeling professionals, are treated the same way as Raw Fields and may generate further insights through the methods described herein. Feature Extractors sometimes reference data sources and fixed tables outside the Record File. For example, a Raw Field may be the name of the US state where an auto accident has occurred, and a corresponding Feature might be an indicator if state law, for that US state, allows for partial fault assignment. The Feature Extractor algorithm, in such an example, would be a look-up table providing that indicator for each US state. Look-up tables that are used to transform Raw Fields into Features are referred to here as “Dictionaries”, and Features created thus are referred to here as “Lookup Features”.

In accordance with an embodiment, the system creates a new type of Lookup Features where the associated Dictionaries are generated from a portion of the modelling-ready data set aside for that purpose. The set-aside portion of the modelling-ready data is referred to as the “Insights Set”, the associated Dictionaries as “Insights Dictionaries”, and the associated Lookup Features as “Insights”.

Embodiments are described herein with respect to at least three phases of the insight generation process: (1) Creation of a “Raw Insights Dictionary” from the Insights Set, with such dictionary identifying every Label-Value pair found at least once in the Insight Set and containing descriptive statistical information regarding all Insight Set Records where the Label-Value pair was found. Such descriptive statistical information may include the number of occurrences, the average value of the Target Field for those occurrences, and, potentially higher distribution moments or other descriptive statistical metrics; (2) the aggregation of the Raw Insights Dictionary into an “Aggregated Insights Dictionary”, where entries that have too few associated exemplars are aggregated with other entries that are presumed to have affinity with respect to their predictive information; and, (3) creation of Insights, in the remaining (non-Insight Set) modelling-ready data, through Lookup Feature Extraction algorithms, from the Aggregated Insights Dictionary.

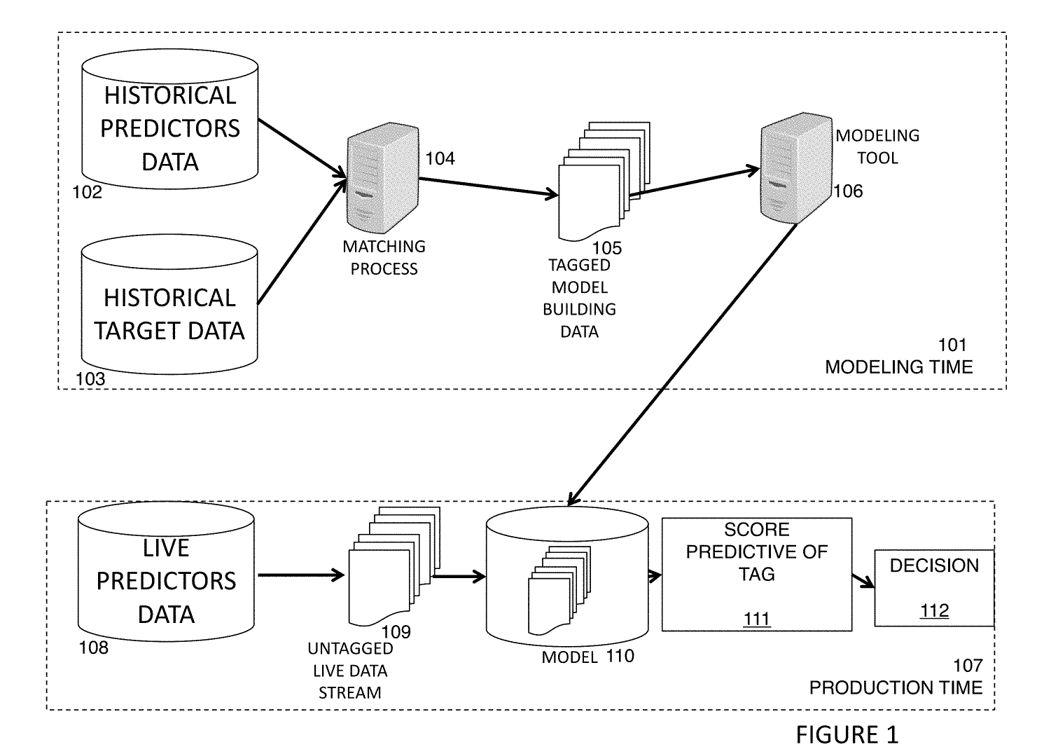

Turning to FIG. 1, a general overall process of predictive statistical modeling is described as may be known to persons skilled in the art, resulting in the creation of a predictive statistical Model 110 at Modeling Time 101. The model 110 is created using Historical Predictors Data presented in the form of a Record File 102, as well as corresponding Target Tags 103. A Matching Process 104, for example the JOIN command or other commands in the SQL computer language, is used to attach the two sources and form the Tagged Model Building Data 105. Tagged Model Building Data 105 is a Modeling-ready Tagged Records File as defined above. A Modeling Tool 106, for example the Stepwise Logistic Regression PROC in SAS, available from the SAS Institute, is then used to generate Model 110 from Tagged Model Building Data 105. Subsequently, during a Production Time 107, Live Predictors Data 108, a records file of substantially the same form and information content as the Historical Predictor File 102, generates an Untagged Live Data Stream 109 as a set of individual cases, analogous to individual Records in the historical data, which arise and require a decision. Model 110 is then applied to the individual cases in the Untagged Live Data Stream 109 and generates, for each, a corresponding Score predictive of the (yet unknown) Tag 111. The Score 111 is then utilized to affect a business Decision 112 for the specified case.

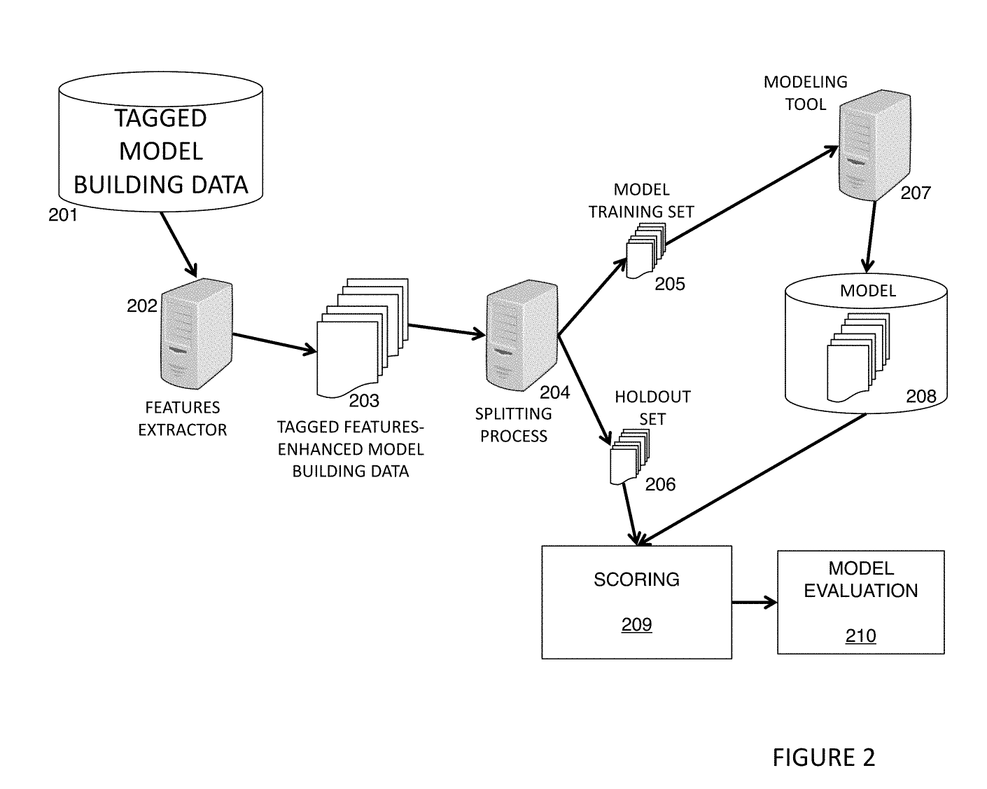

Further detailing the modeling process, a particular modeling process, as may be known to persons skilled in the art, is described with reference to FIG. 2. Tagged Model Building Data 201 is enhanced by the use of Features Extractors 202 algorithms. Such algorithms preferably use the Raw Fields of the Tagged Model Building Data 201 to generate additional Fields, referred to as Features, which may provide additional predictive power. The product of this step is a Tagged Features Enhanced Model Building Data 203. The data is then divided by a Splitting Process 204, for example a randomization based on a unique record identifier, into two sets: A Model Training Set 205 and a Holdout Set 206. The two sets are identical to each other in Record structure, but contain different Records. Training set 205 is used by a Modeling Tool 207 to build a Model 208. If the Model 208 was built well, it will be able to generate prediction of the Target for exemplars not used in training it. To test and evaluate the Model 208, records in the Holdout Set 206, which are exemplars not used in training the model 208, are scored by a Scoring Process 209 that applies the Model 208 to each record. Finally, a Model Evaluation Process 210 compares the scores generated by the Scoring Process 209 with the actual Tags for each Exemplar Record and produces a computation of Model performance using a performance metric, for example KS, that is appropriate for the purpose at hand.

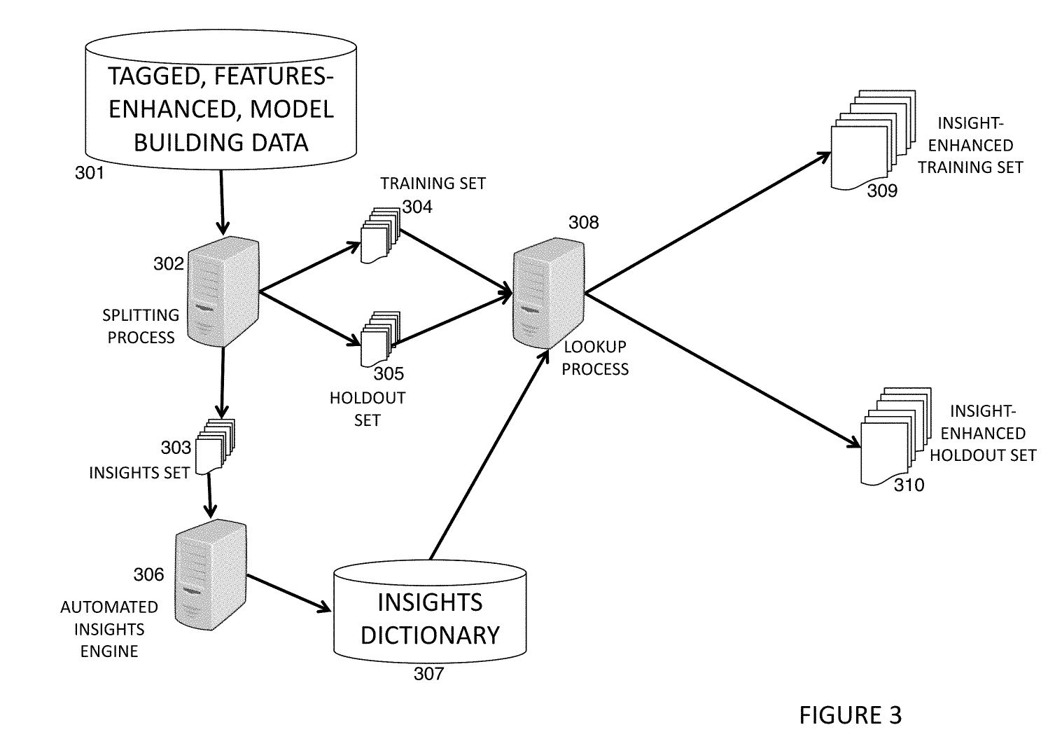

Turning to FIG. 3, an improved statistical modeling process is described, in accordance with an embodiment of the invention. Tagged, Features Enhanced, Model Building Data 301 is divided by a splitting process 302 into three sets: an Insights Set 303, a Training Set 304 and a Holdout Set 305. The Insights Set 303 is used by an Automated Insights Engine 306 to generate one or more Insights Dictionary 307. A Lookup Process 308 utilizing the Insights Dictionary 307 is applied to every Field in every Record in both the Training Set 3.04 and the Holdout Set 305 to generate new Fields, referred to here as Insights, and form, respectively, the Insights Enhanced Training Set 309 and Insights Enhanced Holdout Set 310. These two Sets are then used to complete the modeling process, as described above with reference to elements 205-210 in FIG. 2. In an embodiment, the process creating Insights Enhanced Holdout Set 310, as well as the scoring process described above with reference to FIGS. 1 and 2, are accomplished entirely without knowledge of the tag for members of the Holdout Set. In a live production environment, such as at Production Time 107, where predictors are known but the tag is not known, the same processes are preferably used, as would be understood by a person skilled in the arts, to produce predictions indicative of the then-unknown tag.

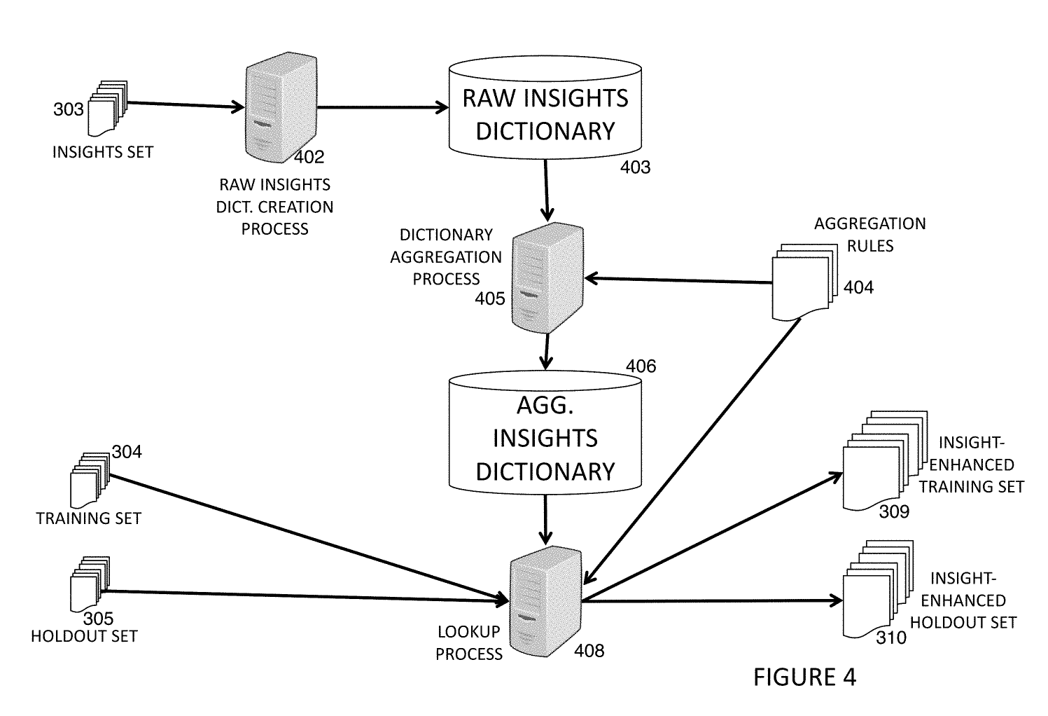

Turning to FIG. 4, the creation and use of Insights Dictionary 307 is further detailed, in accordance with an embodiment. The Insights Set 303 is provided to a Raw Dictionary Creation Process 402. This process identifies all Label-Value pairs for all Fields of all Records in the Insights Set 303. Every such unique pair generates one entry in the Raw Insights Dictionary 403. The entry preferably lists the number of unique Records containing the pair in the Insights Set 303, the average value of the Target for all such Records, and potentially higher moments and other descriptive statistical metrics of the Target among those Records. The Raw Insights Dictionary 403 is further refined by a Dictionary Aggregation Process 405 to produce an Aggregated Insights Dictionary 406 by combining dictionary entries that do not meet specified statistical significance criteria with other entries with the same Label and related Values under pre-defined Aggregation Rules 404 until all entries are either statistically significant or cannot be further combined. The Lookup Process 408 utilizes the Aggregated Insights Dictionary 406 to add Insights Fields to the Training Set 304 and Holdout Set 305 forming the Insighted Training Set 309 and Insighted Holdout Set 310 by looking up, in the Aggregated Insights Dictionary 406, every Label-Value pair found in every Field of every Record and returning one or more descriptive statistical metric, for example the average target value, as the corresponding Insight. When a Label-Value pair found in the Training and Holdout Sets 304, 305 is not present in the Aggregated Insights Dictionary 406, the Aggregation Rules 404 are used by the Lookup Process 408 to find the Label-Value pair from among those that are present in the Aggregated Insights Dictionary 406 that the pair would have first aggregated into, and return the Insights corresponding to that pair.

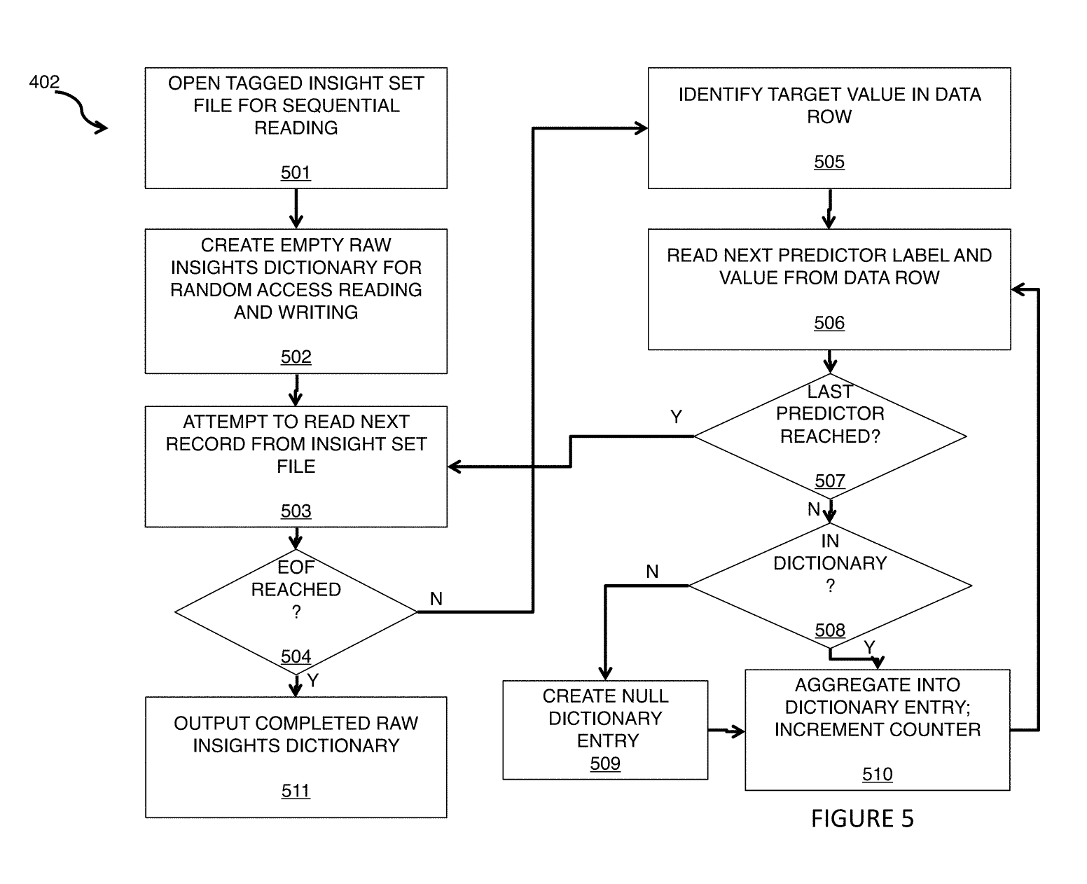

The Raw Insights Dictionary Creation Process Process 402 is further detailed with reference to FIG. 5. The process begins with the opening of the Insights Set Record file for sequential reading at step 501 and the creation of an empty Raw Insights Dictionary at step 502 as a data structure that permits creation, reading or modification of entries in any order, for example the Dictionary data structure of the Python programming language. The process continues at step 503 by attempting to read from the Insights Set file, in sequence, each Record. After each attempt to read a Record, the process checks if the end-of-file (e.g., EOF) was reached at step 504. If the end-of file was reached, the process concludes and the now-completed Raw Insights Dictionary is outputted at step 511 for use by subsequent processes. If EOF was not reached and a Record was successfully read, then the Value of the Target Field is identified from the record at step 505. The process continues at step 506 by attempting to read from the Record, in sequence, each Predictor Field Label and corresponding Value. After each attempt to read a Predictor Field Label and Value, at step 507 the process checks if the attempt failed because all Fields have already been read. If so, then the processing of the Record is finished and the process continues by returning to step 503 and attempting to read the next Record. Otherwise, if a Label-Value pair was successfully read, then the Dictionary created in step 502 is queried at step 508 to check if there is already an entry for the same Label-Value pair. If there is not an entry for the Label-Value pair, a Null entry—indicating a 0 count and no descriptive statistics—is created at step 509. The entry for the Label-Value pair is then updated at step 510 by incrementing the count of the number of Records that include the Label-Value pair and also the descriptive statistics of the Target. Processing then continues by returning to step 506 and attempting to read the next Predictor Field Label and Value.

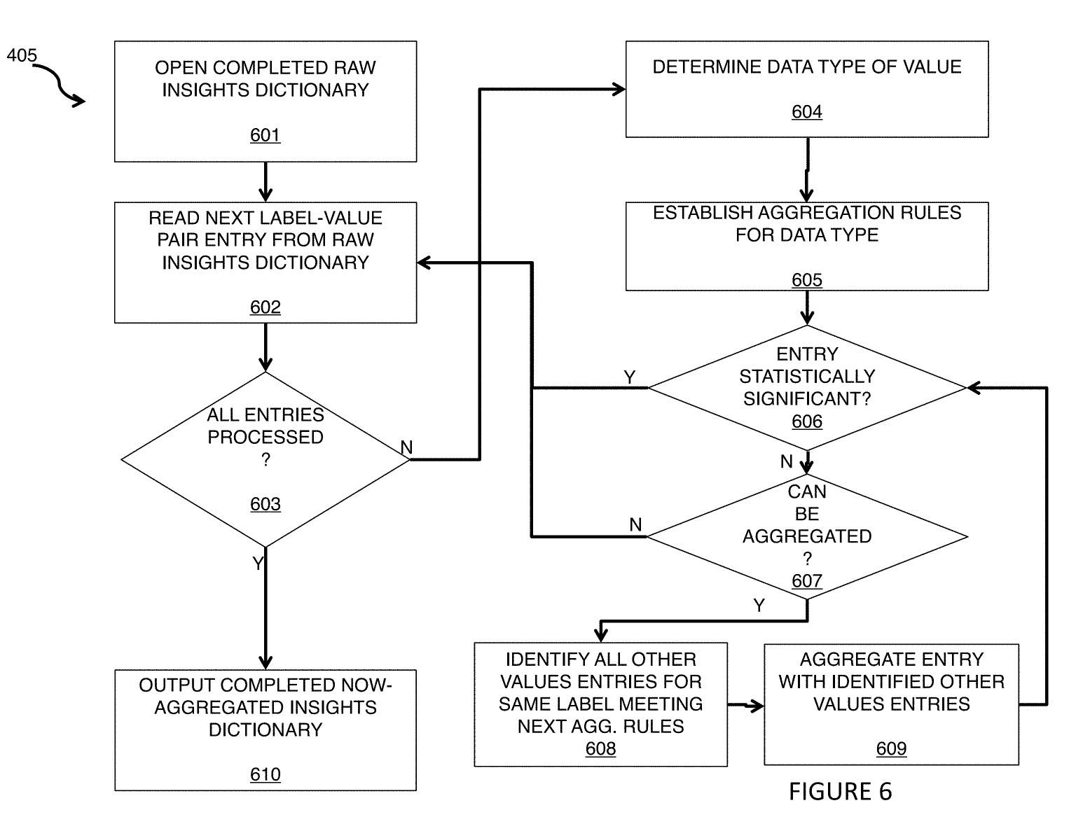

Turning to FIG. 6, Dictionary Aggregation Process 405 is further detailed, in accordance with an embodiment. The process begins at step 601 by opening the completed Raw Insights Dictionary 408 (e.g., created from step 511), as a data structure that permits creation, reading or modification of entries in any order, for example the Dictionary data structure of the Python programming language. So as to avoid circularity, two copies of the Raw Insights Dictionary are preferably produced. One copy is updated in the aggregation process, and eventually becomes the Aggregated Insights Dictionary. The other copy remains unchanged so as to continue availing non-aggregated values to the aggregation processes. The process continues at step 602 by attempting to read from the Raw Insights Dictionary each entry in an order that assures process termination. After each attempt to read an entry, the process checks at step 603 if all Entries have already been processed. If so, the process concludes and the now-completed Aggregated Insights Dictionary is outputted at step 610 for use by subsequent processes. If not, and an entry was successfully read, then the type of data in the Value is determined at step 604. The data type is preferably already be known from, e.g., metadata information supplied with the data file, or it is selected by a practitioner based on content understanding. Alternatively, the data type is algorithmically inferred from the label or value or both. Because the Values for the same Label may have different data types in different Records, the determination process preferably accounts for such possibility. To this end, in an embodiment, a set of predefined aggregation rules 404 supplies distinctive aggregation rules for different data types. For example, data types that are continuous numeric, such as Claim Dollar Amount, may be aggregated with nearby values forming a continuous range of values. In contrast, data types that are digit-wise hierarchical, such as a Standard Industrial Classification (SIC) code, as defined and maintained by the United States government, may be aggregated through digit truncation. The correct aggregation rule is determined at step 605. Once the aggregation rule is established, a test is performed at step 606 to determine if the Entry is statistically significant. An entry is said to be statistically significant if the descriptive statistics metrics, for example average value, of the Target as stored by the entry is predictive, to within specified tolerances, of the same metrics if measured from an arbitrarily large population of records with the same Label-Value pair as the entry. The calculations necessary to determine if an entry is statistically significant are familiar to a person skilled in the arts of statistics. If an entry is determined to be statistically significant then it requires no further aggregation and processing continues at step 602 with the next entry. If an entry is not statistically significant, then another test is performed to determine if the identified aggregation rule can be applied. If it cannot, then no further aggregation is possible and it is accepted that the entry will remain not statistically significant, and processing continues at step 602 with the next entry. If the entry can be aggregated, however, the process proceeds at step 608 by identifying all other entries meeting the next immediate aggregation rule, and aggregate them together at step 609. The newly aggregated entry is again tested for Statistical Significance at step 606, and the process continues until either enough entries have been aggregated to achieve statistical significance, or no further aggregation is possible under the rules.

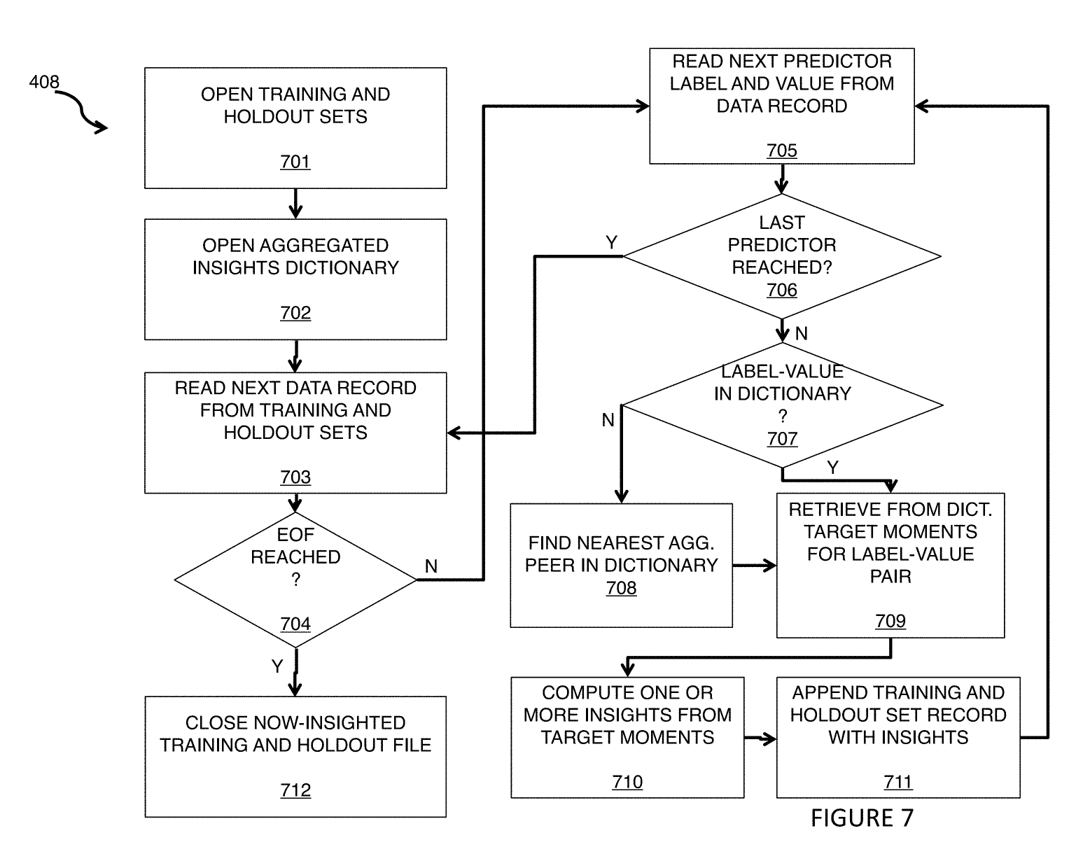

Lookup Process 408 is now described in further detail with reference to FIG. 7. The process begins at step 701 with the opening of the Training and Holdout Sets Record files for sequential reading and record appending, followed by the opening of the Aggregated Insights Dictionary at step 702 as a data structure that can be read in any order, for example the Dictionary data structure of the Python programming language. The process continues at step 703 by attempting to read from the Training and Holdout Sets files, in sequence, each Record. After each attempt to read a Record, the process checks at step 704 if the end-of-file (e.g., EOF) was reached. If the end-of-file was reached, the process concludes at step 712 and the now-Insighted Training and Holdout Sets Records Files are complete. If EOF was not reached and a Record was successfully read, then the process continues at step 705 by attempting to read from the Record, in sequence, each Predictor Field Label and corresponding Value. After each attempt to read a Predictor Field Label and Value, the process checks at step 706 if the attempt failed because all Fields in the record have already been read. If so, then the processing of the Record is finished and the process continues by attempting to read the next Record at step 703. Otherwise, if a Label-Value pair was successfully read, then the Aggregated Insights Dictionary is queried at step 707 to determine if an entry exists for the specified Label-Value pair. If no pair is found then Aggregation Rules 404 are successively applied to the Value at step 708, in a manner similar to steps 606 through 609, so as to identify the nearest peer existing in the Aggregated Insights Dictionary that the Record's Label-Value pair would have aggregated to in the Dictionary Aggregation Process. The descriptive statistics corresponding to the Record's Label-Value pair or its nearest aggregation peer are then retrieved at step 709 from the Dictionary data structure (which have previously stored, e.g., at step 510 or aggregated at step 609. At step 710, the retrieved descriptive statistics are preferably used to compute one or more Insights, for example the average target value corresponding to the specific Label-Value pair. The Insights are then appended to the corresponding Record as new fields with new labels at step 711, and the process proceeds to the next Predictor Label and Value at step 705.

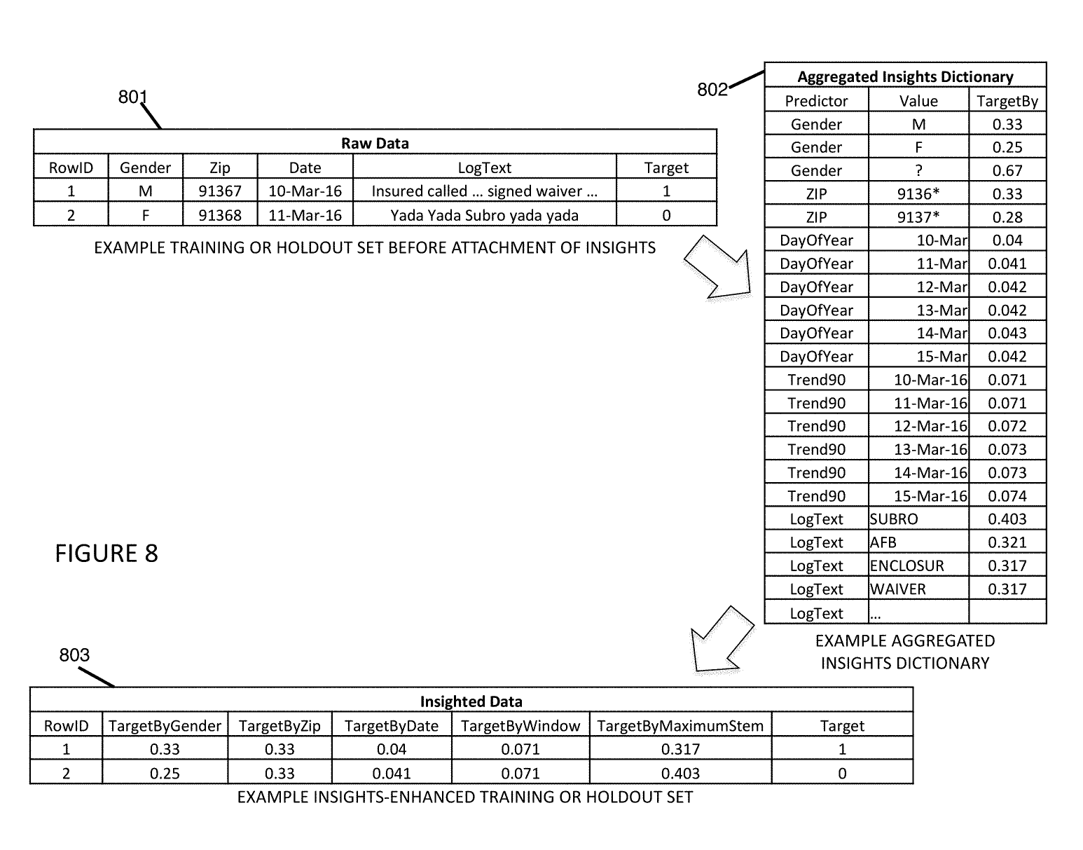

FIG. 8 provides a simplified example of the Insights Attachment Process, in accordance with an embodiment. An example Training or Holdout Set Records File 801 is provided. The file has two records and six fields. The first Field, RowID, is a unique identifier for matching purposes but with no information content. The next four Fields: Gender, Zip, Date, and Log Text, are examples of Predictors of various data types. The last Field, Target, is the Tag. Also, in the example, a previously generated example Aggregated Insights Dictionary 802 is illustrated. The Dictionary provides a list of Predictor-Value pairs and corresponding descriptive statistics, in this example, Average Target Value for each combination. The Dictionary has been constructed exclusively from the Insights Set Records File, and not from the Training or Holdout Set Records Files. The Dictionary entries for the Gender Predictor example is simple, it provides for 3 allowed values (“M”, “F”, and “?”). For ZIP, the Dictionary provides aggregated entries under the digit truncation aggregation rule—which is a reasonable rule for a structured coding system such as the US ZIP code system. In the two provided entries example, zip codes were truncated to 4 digit length to achieve statistical significance. DayOfYear, Trend90, and LogText represent examples of even more complex aggregation rule systems designed to capture seasonalization effects, temporal trends in the Target, and natural language processing of Text. After affecting the Insights Attachment Process, additional Insights Fields are created and appended to the Insight-Enhanced Training or Holdout Sets 803. In this example, the Value of first Predictor (Gender) of the first Record is “M”. According to the Aggregated Insights Dictionary, the Average Target Value for all Records (in the Insights Set, not depicted in the Figure) where the Value of the Gender Field is “M” is 0.33. Accordingly, in the outcome Insight-Enhanced Records File, a new Field, labeled “TargetByGender” is created, and, for the corresponding first record, it is populated with the 0.33 value.

Discussion of Data Types and Aggregation Rules

Embodiments of the invention make use of a selection of thoughtful aggregation rules for various data types. In one embodiment, the following Data Type-specific Aggregation Rules are defined:

| Data Type | Example | Aggregation Rule and Discussion |
|---|---|---|
| Continuous | Amount = | Aggregate positives and Negative values separately; “0” |
| quantitative | $500 | gets its own entry with no aggregation; aggregate to |
| | | ranges with approximately equal numbers of entries each |
| | | (for each sign), for example by percentile of value. |
| Hierarchical | ZIP = 92024 | Single Digit Truncation (SDT). Even if coding is not |
| Coding | | strictly digit-wise hierarchical, as long as there is a digit- |
| | | progressive structure, SDT is appropriate. Examples |
| | | include ZIP codes, SIC codes, Phone Numbers, VIN, |
| | | Dewey Decimal Classification, etc. |
| Date | ClaimDate = | Multiple Aggregation Rules may capture different aspects |
| | Jan. 5, 2017 | of predictive information in dates. For example: |

| | |
|---|---|
| 1. | Seasonalization: All dates from the same |
| | DayOfYear are aggregated together. A further |
| | aggregation of 3 days before and after may be used |
| | to average away the effect of day-of-week if dates |
| | from different years are aggregated together. |
| 2. | Trending: A trailing window period (for example |
| | 90 days) is aggregated together. If multiple such |
| | periods are aggregated in the same data set, then |
| | the eventual modelling tool will be cognizant of |
| | shifting temporal trends. |
| 3. | Date difference between 2 dates fields, for |
| | example the day a claim is filed and the day it is |
| | paid, can be treated as a continuous quantitative |
| | data type. Likewise, the difference with a selected |
| | fixed date, for example Jan. 1, 2000, can also be |
| | treated as a continuous quantitative data type. |

| | | |
|---|---|---|
| Low Count | Gender = | When only a small number of possible categorical values |
| Categorical | Male | exist, for example, a “Gender” Field may have only the |
| | | values “Male”, “Female”, and “Unknown”, it may be best |
| | | to aggregate all non-statistically significant entries into a |
| | | single “Others” entry. |
| High Count | Provider = | Sometimes, for example for fields such as “Employer” or |
| Categorical | Mercy | “Hospital” name, the number of possible categorical |
| with | Hospital | values is so high as to have most records in Entries that |
| Guidance | | are not statistically significant. If, however, there is a |
| | | guidance process, for example a list of employers and |
| | | associated parameters that are more readily aggregateable, |
| | | for example employees count, such can be used to |
| | | affect aggregation. |
| High Count | Vehicle = | For High Count Categorical data types with no guidance, |
| Categorical | Porsche911CP | single character truncation may have an opportunity to |
| without | | capture some internal logic to the naming convention. |
| Guidance | | |
| Single | Profession = | Stemming, followed by single letter truncation |
| English | Accountant | |
| Words | | |
| Natural | LogText = | Stem all words and create a raw dictionary entry for every |
| Language | “Insured | unique stem. Discard all entries that are not statistically |
| Text | called and . . . ” | significant. Then provide Feature Extractors for various |
| | | metrics, for example “Maximum Stem” for the Stem with |
| | | the highest average target value. |

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

It is understandable to those skilled in the art that all or a part of steps of the processes in the preceding embodiments is preferably implemented by relevant computing hardware instructed by a program. The program may be stored in a computer readable storage medium. The storage medium may include a ROM, a RAM, a magnetic disk or a compact disk.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A system for processing data records in a computer database for predictive modeling, comprising:
a database comprising data records, the data records comprising labeled data fields populated with values;
a first partition of the database for generating an insights dictionary;
a second partition of the database for training a predictive model;
a third partition of the database for evaluating the predictive model;
raw insights dictionary creation means for creating a raw insights dictionary using data from the first partition; and
lookup means for applying insights from an insights dictionary to records in the second and third partitions.

2. The system of claim 1 further comprising dictionary aggregation means for applying one or more aggregation rules to create an aggregated insights dictionary from the raw insights dictionary, and wherein the lookup means is for applying insights from the aggregated insights dictionary to records in the second and third partitions.

3. The system of claim 2 wherein the aggregation rule corresponds to a data-type of fields in the records.

4. The system of claim 2, further comprising computer executable instructions embedded on a fixed tangible medium, which upon execution, cause a computer to perform the steps of:
for each record in the second partition, querying the aggregated insights dictionary for relevant insighted data based on the fields and values in the record; and
appending the relevant insighted data to the record in the second partition.

5. The system of claim 4, further comprising computer executable instructions embedded on a fixed tangible medium, which upon execution, cause a computer to perform the steps of:
training a data model from the second partition using the appended insighted data in the records;
applying the data model to a record in the third set to generate predicted scores for one or more tagged fields in the record; and
comparing the predicted scores to the actual values of the tagged fields.

6. The system of claim 2 wherein the dictionary aggregation means further comprises statistical analysis means for determining the statistical significance of a label-value pair in a data record.

7. The system of claim 3 wherein the aggregation rule corresponds to a data-type that is a string of natural language text.

8. The system of claim 3 wherein the aggregation rule corresponds to a data-type that is a continuous quantitative value.

9. The system of claim 3 wherein the aggregation rule corresponds to a data-type that is a date.

10. The system of claim 3 wherein the aggregation rule corresponds to a data-type that is a category with a large number of possible values.

11. A method for processing data records in a computer database for predictive modeling, the data records comprising labeled data fields populated with values, comprising:
partitioning the data records into an insights set and a modeling set;
generating an insights dictionary using data in the insights set of records;
for each record in the modeling set, querying the insights dictionary for relevant insighted data based on the fields and values in the record; and
appending the relevant insighted data to the record in the modeling set.

12. The method of claim 11 further comprising:
partitioning the modeling set into a training set of records and a holdout set of records;
training a data model from the modeling set using the appended insighted data in the records;
applying the data model to a record in the holdout set to generate predicted scores for one or more tagged fields in the record; and
comparing the predicted scores to the actual values of the tagged fields.

13. The method of claim 11, wherein generating the insights dictionary comprises:
generating a raw insights dictionary, including one entry for each unique label-value pair in the records in the insight set; and
generating an aggregated insights dictionary, including at least one entry for an aggregation of statistically insignificant unique label-value pairs.

14. The method of claim 13, wherein generating the aggregated insights dictionary comprises:
selecting an aggregation rule from a set of pre-defined aggregation rules, the pre-defined aggregation rules corresponding to the data-types of fields in the records;
determining that a first record in the insights set includes a label-value pair that is not statistically significant with respect to other records in the insights set;
determining that the selected aggregation rule is applicable to the first record; and
aggregating the label-value pair from the first record with information in the aggregated insights dictionary according to the aggregation rule.

15. The method of claim 13, wherein generating the raw insights directory comprises:
reading a data record from the insights set;
identifying the value of a target data field in the record;
identifying a predictor field for the target data field;
identifying the value of the predictor field in the record; and
if an entry already exists in the dictionary for the identified predictor field-value combination, incrementing a counter for the entry.

16. The method of claim 14 wherein the selected aggregation rule corresponds to a natural language text data-type, and wherein aggregating the label-value pair comprises stemming the value.

17. The method of claim 14 wherein the selected aggregation rule corresponds to a continuous quantitative data-type, and wherein aggregating the label-value pair comprises grouping the pair with label-value pairs containing values of the same sign.

18. The method of claim 14 wherein the selected aggregation rule corresponds to a hierarchical coding data-type, and wherein aggregating the label-value pair comprises single digit truncation.

19. The method of claim 14 wherein the selected aggregation rule corresponds to a categorical data-type, and wherein aggregating the label-value pair comprises assigning the pair to a designated entry for statistically insignificant values.

20. The method of claim 14 wherein the selected aggregation rule corresponds to a date data-type.
